(19) United States
(12) Patent Application Publication
(10) Pub. No.: US 2024/0342552 A1
(43) Pub. Date: Oct. 17, 2024

(54) DEFENSIVE AND FITNESS PLAYER ANALYSIS USING REMOTE TRACKING IN SPORTS

(71) Applicant: Stats LLC, Chicago, IL (US)

(72) Inventors: Matthew Scott, Chicago, IL (US); Patrick Joseph Lucey, Chicago, IL (US); Joe Dominic Gallagher, Wirral (GB); Michael Stöckl, Munich (DE); Felix Wei, Melbourne (AU); Michael John Horton, Wellington (NZ)

(73) Assignee: Stats LLC, Chicago, IL (US)

(21) Appl. No.: 18/634,321

(22) Filed: Apr. 12, 2024

Related U.S. Application Data
(60) Provisional application No. 63/495,871, filed on Apr. 13, 2023.

(51) Int. Cl. A63B 24/00; A63B 71/06; G06V 20/40

(52) U.S. Cl. CPC A63B 24/0021; A63B 71/0616; G06V 20/42; G06V 20/44; A63B 2024/0025; A63B 2024/0056; A63B 2024/0065; A63B 2220/05; A63B 2220/806

(57) ABSTRACT

The present embodiments relate to tracking player movements from a video broadcast and determining a defensive influence score from the tracked movements of the player. The present embodiments can implement one or more models to generate a defensive influence score that quantifies a defensive intensity of a player during the course of a game. The defensive influence score can include a frame-by-frame machine learning prediction that can be used to estimate the defensive pressure a player is having on another player during the course of the game. Additionally, the present embodiments can capture and estimate fitness metrics, such as sprints and efforts around detected plays such as pick-and-rolls and off-ball screens, which can be good proxies for player effort. Further, event detection outputs (both offensive and defensive metrics), can be used as features to estimate fitness metrics for the player (e.g., player load, sprints, jogs, etc.).

### CROSS-REFERENCE TO RELATED APPLICATIONS

This application claims priority to U.S. Provisional Patent Application Ser. No. 63/495,871, filed Apr. 13, 2023, the entire disclosure of which is incorporated herein by reference.

### FIELD OF THE INVENTION

The present disclosure generally relates to a system and method for tracking player movements from a video broadcast of a sports game and determining one or more metrics from the tracked movements of the player.

### BACKGROUND

Player performance during occurrence of a sporting event (e.g., a basketball game) can be tracked using various techniques (e.g., cameras, sensors, box score data). For instance, team and player statistics can be dynamically tracked during the occurrence of a basketball game. Player statistics can include offensive and/or defensive metrics that track various aspects of the player during the course of the game, such as movement of the player, ball handling metrics, turnovers/errors made, shot attempts, etc.

Metrics relating to player performance can be tracked and aggregated over a number of games, seasons, etc. The aggregated player metrics can be processed to derive detailed insights relating to various aspects of performance of the player.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

In some aspects, the techniques described herein relate to a method including: obtaining a video broadcast of a sporting event; processing each frame of the video broadcast to identify players on a first team and a second team, a location of each identified player, a matchup between each defending identified player and a corresponding offensive identified player, and a distance between each defending identified player and the corresponding offensive identified player; aggregating, for each frame, the distance between a first defending identified player and a first offensive identified player that the first defending identified player is matched up against to generate an aggregated distance between the first defending identified player and the first offensive identified player during the sporting event; and generating a defensive influence score for the first defending identified player based on the aggregated distance of the first defending identified player

In some aspects, the techniques described herein relate to a system including: a processor; and a memory having programming instructions stored thereon, which, when executed by the processor, performs one or more operations including: obtaining a video broadcast of a sporting event; processing each frame of the video broadcast to identify players on a first team and a second team, a location of each identified player, a matchup between each defending identified player and a corresponding offensive identified player, and a distance between each defending identified player and the corresponding offensive identified player; aggregating, for each frame, the distance between a first defending identified player and a first offensive identified player that the first defending identified player is matched up against to generate an aggregated distance between the first defending identified player and the first offensive identified player during the sporting event; and generating a defensive influence score for the first defending identified player based on the aggregated distance of the first defending identified player;

In some aspects, the techniques described herein relate to a non-transitory computer readable medium including one or more sequences of instructions that, when executed by one or more processors, causes the one or more processors to: obtain a video broadcast of a sporting event; process each frame of the video broadcast to identify at least players on a first team and a second team, a location of each identified player, a matchup between each defending identified player and a corresponding offensive identified player, and a distance between each defending identified player and the corresponding offensive identified player; aggregate, for each frame, the distance between a first defending identified player and a first offensive identified player that the first defending identified player is matched up against to generate an both aggregated distance between the first defending identified player and the corresponding offensive identified player during an entirety of the sporting event and average distances between the first defending identified player and the first offensive identified player during a set of time ranges in which the first defending identified player played during the sporting event; and generate a defensive influence score for the first defending identified player based on the aggregated distance of the first defending identified player, wherein the defensive influence score includes both an aggregate defensive influence score for the first defending identified player for the entirety of the sporting event and a set of defensive influence scores for each of the set of time ranges in which the first defending identified player played during the sporting event.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 is a block diagram illustrating a computing environment, according to example embodiments.

FIG. 2 is an example flow process for generating a defensive influence score that quantifies a defensive intensity of a player during the course of a sporting event based on a video broadcast of the game, according to example embodiments.

FIG. 3 is a flow process of an example method for generating a defensive influence score that quantifies a defensive intensity of a player during the course of a sporting event based on a video broadcast of the game, according to example embodiments.

FIGS. 4A-4C can illustrate different frames of a video broadcast and different positions of players and the ball during the course of the game, according to example embodiments.

FIGS. 5A-5B illustrate representations of an example defensive influence score for a player, according to example embodiments.

FIGS. 6A-6B illustrate example player cards illustrating various offensive and defensive metrics of the player, according to example embodiments.

FIG. 7A is a block diagram illustrating a computing device, according to example embodiments.

FIG. 7B is a block diagram illustrating a computing device, according to example embodiments.

FIG. 8 is a flow process of an example system and method for generating one or more fitness metrics, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range +/−10%.

Reference will now be made in detail to the exemplary embodiments of the present disclosure described below and illustrated in the accompanying drawings. Wherever possible, the same reference numbers will be used throughout the drawings to refer to same or like parts.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims.

Player performance during occurrence of a sporting event (e.g., a basketball game) can be tracked using various techniques (e.g., cameras, sensors, box score data). For instance, team and player statistics can be dynamically tracked during the occurrence of a sporting event. Player statistics can include offensive and/or defensive metrics that track various aspects of the player during the course of the game, such as movement of the player, ball handling metrics, turnovers/errors made, shot attempts, etc.

Metrics relating to player performance can be tracked and aggregated over a number of games, seasons, etc. The aggregated player metrics can be processed to derive detailed insights relating to various aspects of performance of the player.

A key metric when analyzing the performance of a player, as well as forecasting future performances (e.g., forecasting professional basketball performances of a player from college tracking data), can be a fitness/defensive effort a player over a period of time. The fitness/defensive effort of a player can specify a relative intensity that a player plays defensively or an impact the player has on the game defensively during the course of the game. For example, the fitness/defensive effort can identify a tendency that a player puts in less effort in a last 10 minutes of a game or that the player does not move as dynamically during certain times of the game.

In many instances, when tracking data is available across an entire game using an in-venue solution, this process is quite straight forward and mature. However, with the advent of player tracking data from remote tracking, some methods may be used to estimate defensive effort as well as other fitness metrics. The present embodiments can be used to determine player fitness/defensive effort from remote tracking data in sports (e.g., basketball, soccer, tennis).

Particularly, the present embodiments can illustrate how a defensive match-up feature can be used, where defensive influence of a player can be captured during a game (e.g., during every frame of a video broadcast). The information can be viewed through a longitudinal lens (e.g., over the course of a game, season). Additionally, the present embodiments can capture and estimate fitness metrics, such as sprints and efforts around detected plays such as pick-and-rolls and offball screens, which can be good proxies for player effort.

The present embodiments can implement one or more models to generate a defensive influence score that quantifies a defensive intensity of a player during the course of a game. The defensive influence score can include a frame-by-frame machine learning prediction that can be used to estimate the defensive pressure a player is having on another player during the course of the game. For example, a defensive influence score of 0 can include no pressure on the opposing player, while a defensive influence score of 100 is a very close guard to the opposing player. Further, event detection outputs (both offensive and defensive metrics), can be used as features to estimate fitness metrics for the player (e.g., player load, sprints, jogs, etc.).

The defensive effort and fitness metrics can be applied where there is full tracking data from all players from in-venue solutions. However, from remote tracking (e.g., due to missing frames due to players being out of view) there may not be a solution to approximate defensive effort and fitness metrics that have been created previously.

While basketball is generally used herein as an illustrative example, the present embodiments are not limited to basketball. For instance, the present embodiments can be applied to other sports, such as soccer, basketball, baseball, football, rugby, cricket, team sports, individual sports, etc.

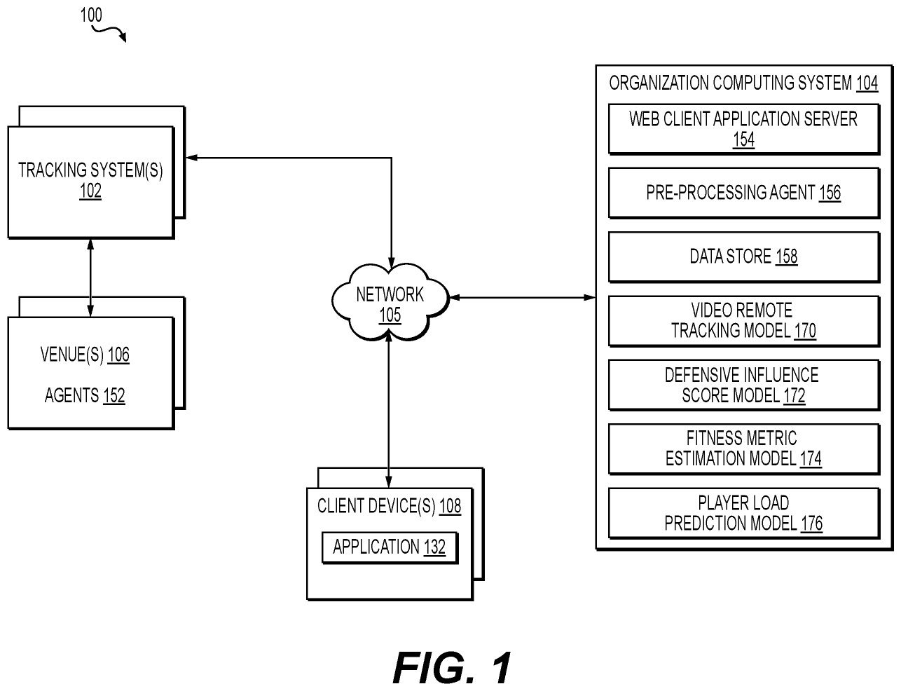

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFD), near-field communication (NFC), Bluetooth™, low-energy Bluetooth™ (BLE), Wi-Fi™ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication with one or more components located at venue 106. For example, venue 106 may be configured to host a sporting event that includes one or more agents 152. Tracking system 102 may be configured to record the motions of all agents (e.g., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x, y) position) for all agents and objects on the playing surface for each frame in a game file. Tracking system 102 may receive an in-venue video feed (e.g., from in-venue cameras) or a broadcast video feed and may identify position information, movement information, trend information, sport event information, and/or other related information based on the in-venue feed and/or broadcast feed (e.g., using one or more trained machine learning models trained to identify such information).

Tracking system 102 may be configured to communicate with organization computing system 104 via network 105. Organization computing system 104 may be configured to manage and analyze the data captured by tracking system 102. Organization computing system 104 may include at least a web client application server 154, a pre-processing agent 156, a data store 158, a video remote tracking model 170, a defensive influence score model 172, a fitness metric estimation model 174, and a player load prediction model 176.

Each of the video remote tracking model 170, a defensive influence score model 172, a fitness metric estimation model 174, and a player load prediction model 176 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Pre-processing agent 156 may be configured to process data retrieved from data store 158 prior to input to any of the video remote tracking model 170, a defensive influence score model 172, a fitness metric estimation model 174, and a player load prediction model 176. Pre-processing agent 156 may then extract the one or more portions of the tracking data from the one or more streams of data and normalize the one or more portions of data for processing.

Data store 158 may be configured to store various source of information. For example, the data store 158 can store historical game data, in-game data, and/or outputs derived from any of the models as described herein. The historical game data can include a repository of historical team and player data for one or more sporting events. The data store can store historical data tracking aspects of previous basketball games for each player and team at multiple levels/leagues (e.g., professional basketball leagues internationally, collegiate basketball leagues). The data store 158 can further store offensive/defensive metrics (e.g., 202, 204) for each player.

The video remote tracking model 170 can process a video broadcast of a sporting event (e.g., basketball game) to track various aspects of the game. For example, the video remote tracking model 170 can identify, in each frame of the video, a location of each player on the court. Further, the video remote tracking model 170 can process each frame to identify a matchup between each offensive player and a corresponding defensive player and a distance each defensive player is from the corresponding offensive player (e.g., a player each defensive player is guarding). The video remote tracking model 170 can implement one or more image processing techniques to identify features in each video frame (e.g., identify each player) and determine a location of each player on the court.

In some instances, the video remote tracking model 170 can be used to detect offensive events occurring during the game. An offensive event can include a pick-and-roll or screen set by offensive players. Such events can be detected by the video remote tracking model 170 detecting specific positions and/or movements of multiple players across one or more frames that resemble any of a set of offensive events. The video remote tracking model 170 can further track defensive movements in response to the offensive events, such as a defensive movement around a screen.

The defensive influence score model 172 can include a machine learning model configured to calculate a defensive influence score for a player. The defensive influence score can specify a relative defensive influence of the player during the course or the game (or a series of scores calculated for each number of minutes the player plays). The defensive influence score model 172 can use an aggregated distance the defensive player is from a corresponding offensive player to determine how close the defensive player guards the offensive player, which can be indicative of a defensive effort the defensive player gives during the game. The defensive influence score can be based on a score range (e.g., 0-100), with a lower score indicating a greater distance of a defensive player to a corresponding offensive player (and thus a softer coverage on defense), and a high score indicating a lower distance to the offensive player (and a tighter coverage on defense).

The fitness metric estimation model 174 can process the defensive influence score and/or the offensive/defensive metrics for the player to determine one or more fitness metrics of the player. Fitness metrics can relate to movements and defensive intensity of the player. Example fitness metrics can include player sprints, jogs, on-court time with no movement, average distance to an offensive player during a pick-and-roll or screen, etc. The fitness metrics can each include scores (e.g., 0-100 scores) that can be aggregated to determine an overall fitness metric of the player. In some instances, fitness metrics can be based on different time ranges that the player is on the court. In this example, if the player reduces the defensive influence score as the game progresses, the fitness metrics can be negatively impacted as the game progresses.

The player load prediction model 176 can be configured to predict a future load (e.g., minutes played, effort given) of a player for a remainder of a game, for subsequent games, etc. The future load can include predicted values for a player, such as a predicted number of minutes played, a projected average distance the player maintains to an offensive matchup, sprints during the game, etc. The predictions generated by the player load prediction model 176 can provide insights into defensive effort predicted to be provided by the player in a remainder of an ongoing game or an upcoming game.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 132. Application 132 may be representative of a web browser that allows access to a website or a stand-alone application. Client device 108 may access application 132 to access one or more functionalities of organization computing system 104. Client device 108 may communicate over network 105 to request a webpage, for example, from web client application server 154 of organization computing system 104. For example, client device 108 may be configured to execute application 132 to access content managed by web client application server 154. The content that is displayed to client device 108 may be transmitted from web client application server 154 to client device 108, and subsequently processed by application 132 for display through a graphical user interface (GUI) of client device 108.

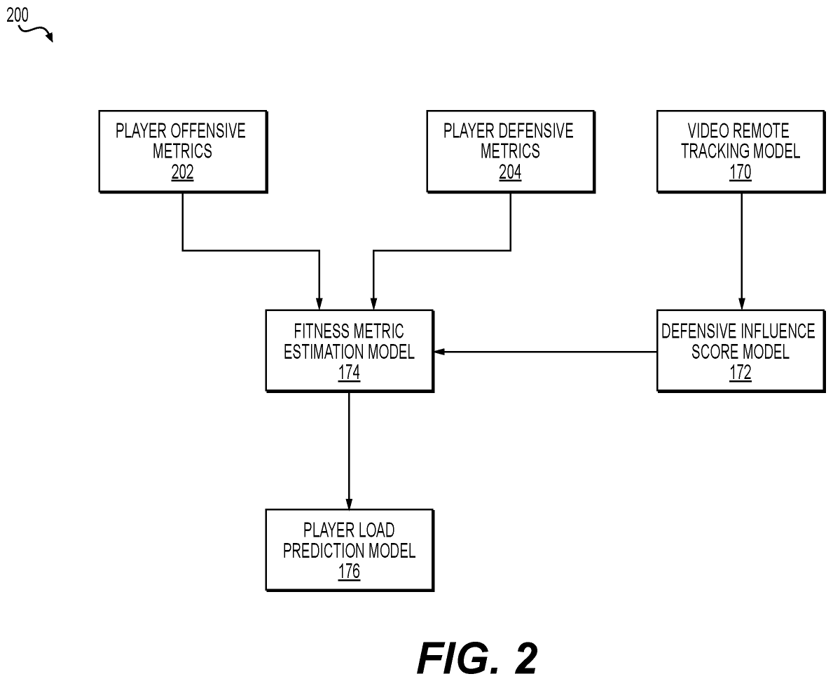

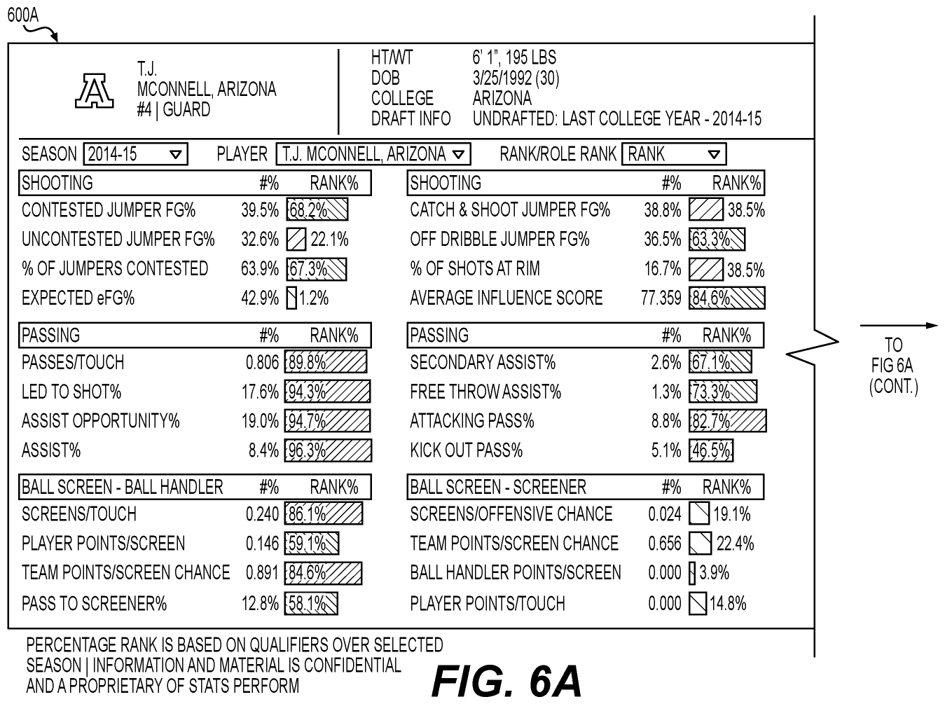

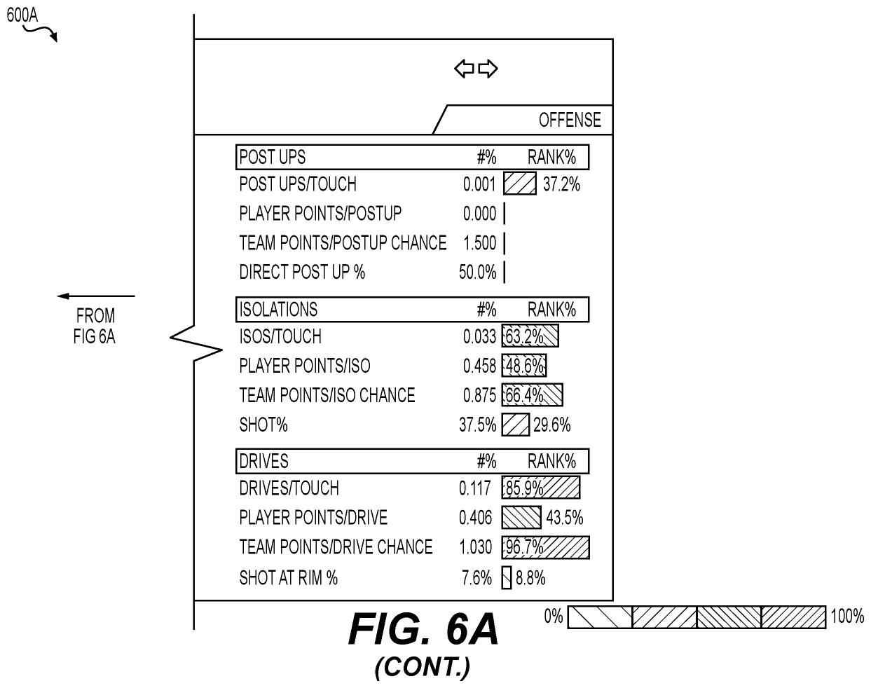

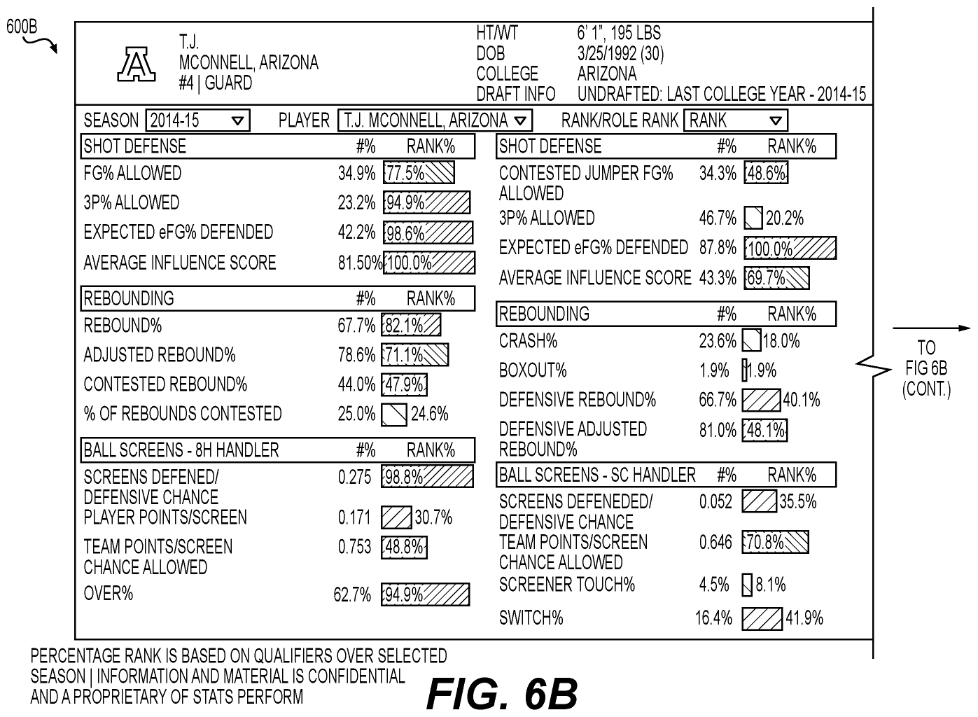

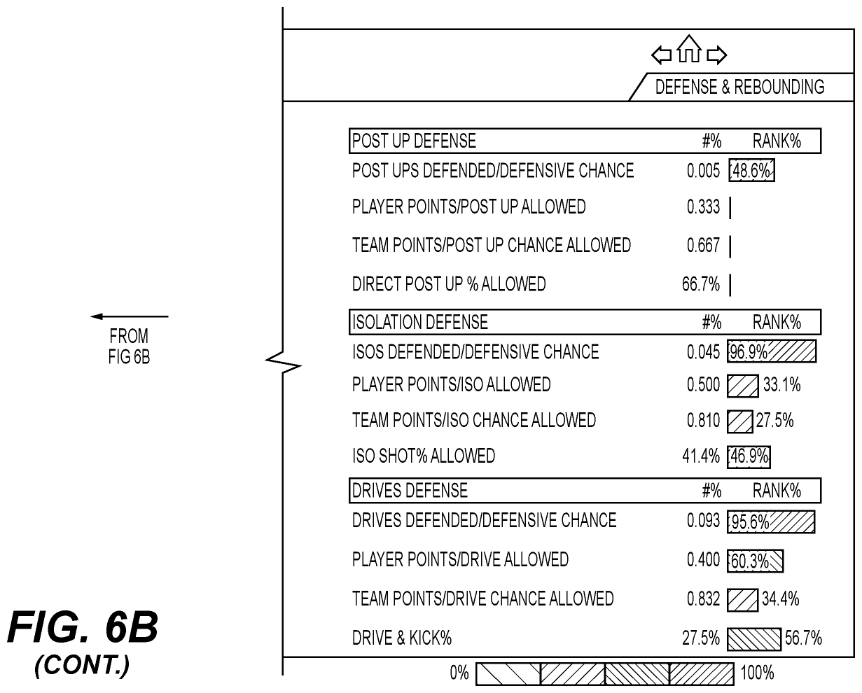

FIG. 2 is an example flow process 200 for generating a defensive influence score that quantifies a defensive intensity of a player during the course of a sporting event based on a video broadcast of the game. As shown in FIG. 2, various sources of input data (e.g., player offensive metrics 202, player defensive metrics 204, etc.) can be obtained for processing as described herein. The metrics 202, 204 can include statistical data obtained and accrued for a player over time (e.g., previous games, seasons, etc.). For example, offensive metrics 202 can include statistics relating to shooting, ball handling, passing, on-ball screens, off-ball screens, etc. Example defensive metrics 204 can include statistics relating to shot defense, rebounding, screen defending, etc. The metrics 202, 204 can include statistics for any league that the player participated, such as collegiate or professional leagues. Example player cards illustrating offensive and defensive metrics are shown in FIGS. 6A-6B

Further, a video remote tracking model 170 can obtain a video broadcast of a sporting event and derive insights into the video. The video remote tracking model 170 can implement one or more image recognition and machine learning techniques to identify players of each team, matchups between opposing players on each team, a position of each player on a court, a distance between opposing players, etc.

In some instances, a frame of the video broadcast may not depict each player (e.g., due to a player being out of the frame). In such instances, the video remote tracking model 170 can estimate a player location on the court based on a prior frame in which the player was last identified.

The identified information from the video broadcast can be fed into a defensive influence score model 172. The defensive influence score model 172 can implement one or more machine learning techniques to determine a defensive influence of a player during a course of the game. The defensive influence of the player can be based on an aggregate distance a defending player has to a corresponding offensive player the defender is guarding. A greater distance (e.g., greater than a respective distance threshold) can indicate a softer defense by the defender, and thus a lower defensive influence on the game. In contrast, a lesser distance can indicate a tighter defense by the defender, and thus a greater defensive influence on the game.

In some instances, the defensive influence score can also be based on a defender's distance to a corresponding offensive player in response to a detected offensive event (e.g., a screen, a pick-and-roll). For example, a defender that keeps a tighter distance (e.g., within a respective distance threshold) to an offensive player in response to an offensive event can have a greater defensive influence score than a defender that keeps a greater distance from the offensive player during the offensive event.

The output from the defensive influence score model 172 can include a score (e.g., 0-100 score) indicative of a defensive influence of a player during a game. In some instances, the defensive influence score can be broken down by time duration, such as approximately 5 or approximately 10 minute intervals in which a defender played a game. The time-separated scores can be indicative of a defensive intensity of the player over the course of the game, such as identifying that the player plays a softer defense after playing more than approximately 20 minutes a game, for example.

The defensive influence score and/or the metrics 202, 204 for a player can be fed into a fitness metric estimation model 174. The fitness metric estimation model 174 can generate one or more fitness metrics for a player. Example fitness metrics can include player sprints, jogs, on-court time with no movement, average distance to an offensive player during an offensive event (e.g., pick-and-roll or screen), etc. The fitness metrics can be indicative of an overall fitness of a player and/or a defensive intensity of the player during the course of the game. In some instances, any of the defensive influence score and/or the fitness metrics can be normalized across multiple players of a similar position (e.g., guards, forwards).

The fitness metrics can be fed into a player load prediction model 176. The player load prediction model 176 can predict a load (e.g., a number of minutes played, a predicted number of sprints, jogs, defensive intensity, screen defense) of a player during a remainder of a game or during an upcoming game.

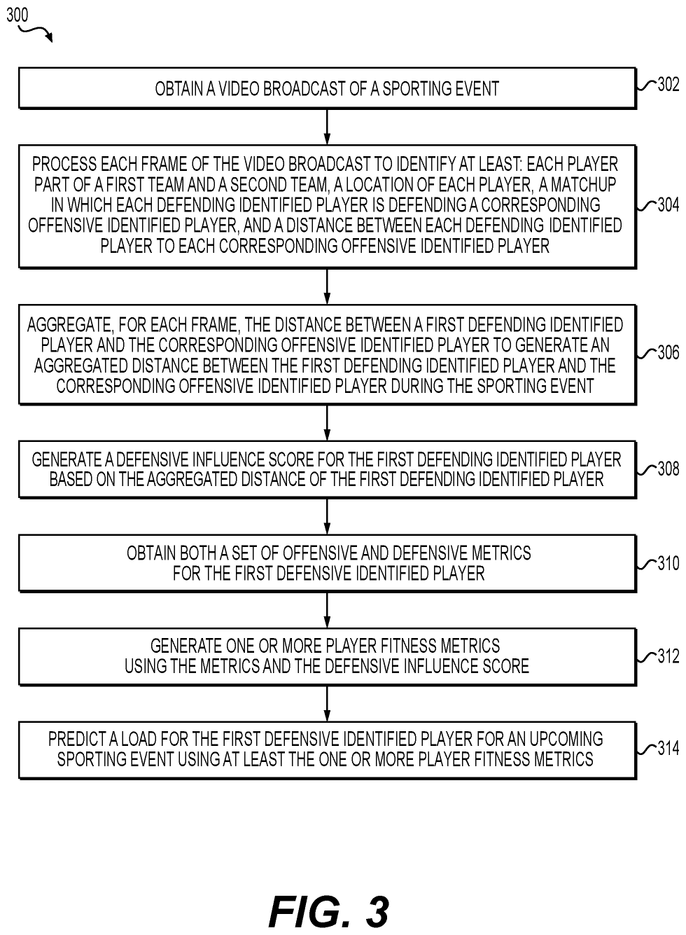

FIG. 3 is a flow process 300 of an example method for generating a defensive influence score that quantifies a defensive intensity of a player during the course of a sporting event based on a video broadcast of the game.

At step 302, a video remote tracking model (e.g., 170) can obtain a video broadcast of a sporting event. The video broadcast can be a live or replay of a sporting event (e.g., basketball game). In some instances, the video can include one or more angles captured by different cameras during the broadcast. In some instances, the video broadcast is a live broadcast or a replay of the basketball game.

At step 304, the video remote tracking model 170 can process each frame of the video broadcast to identify one or more of: each player part of a first team and a second team, a location of each player, a matchup in which each defending player is defending a corresponding offensive player, and a distance between each defending player to each corresponding offensive player. In particular, a first defending player can be identified and a distance between the first defending player and a corresponding offensive player in which the first defending player is guarding.

In some instances, the method can include processing one or more frames of the video broadcast to detect an occurrence of an offensive event. Example offensive events can include a pick-and-roll play, an on-ball screen, off-ball screen, etc. The video remote tracking model can identify an offensive event occurring based on positions of offensive players and/or movements of the offensive players in a pattern similar to that of an offensive event. The method can also include predicting a player effort of the first offensive player in response to the detected offensive event using both the defensive influence score and the one or more player fitness metrics.

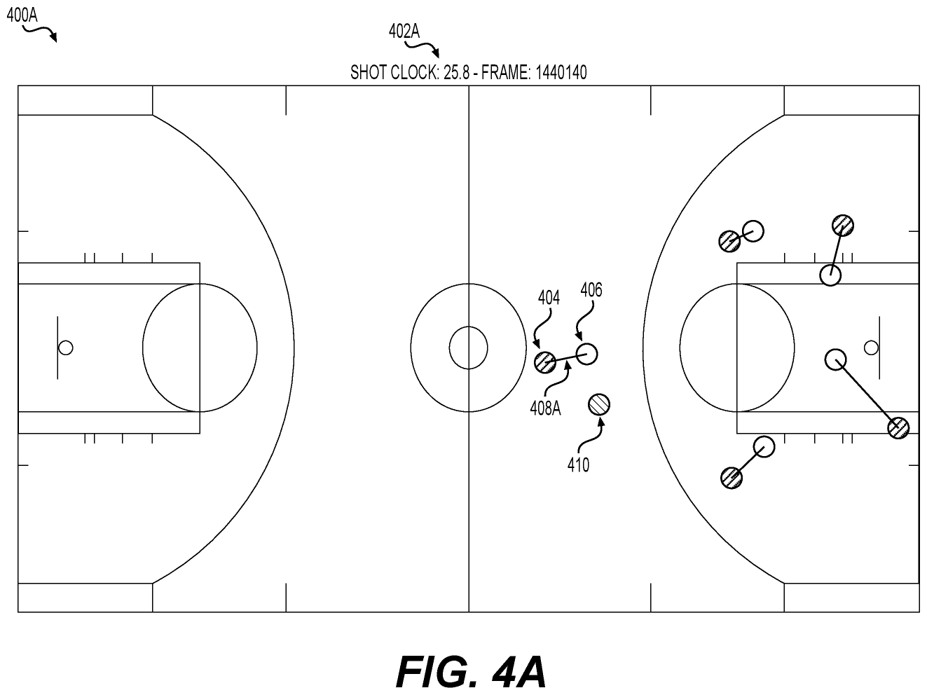

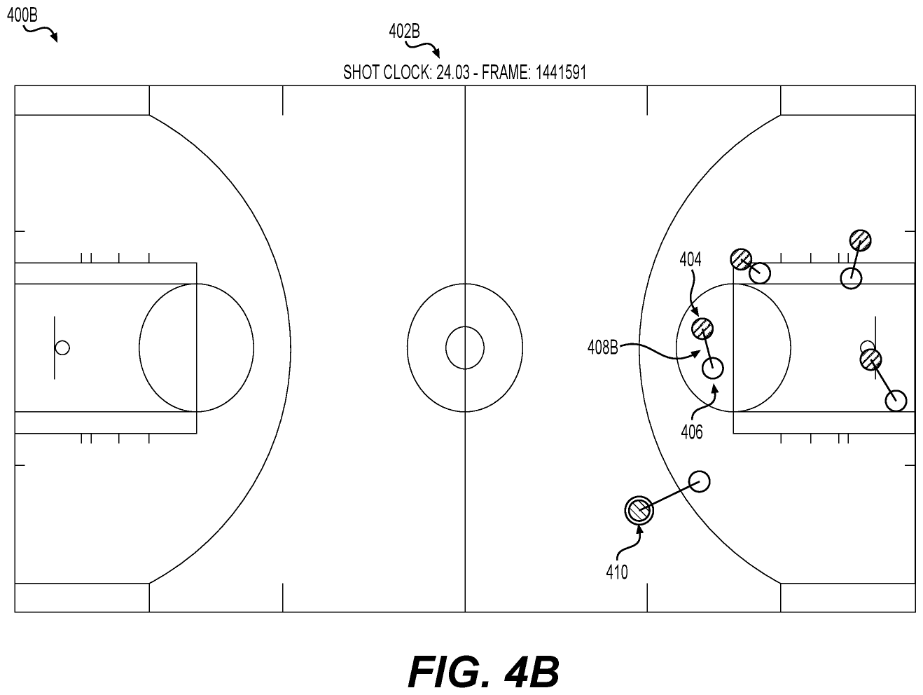

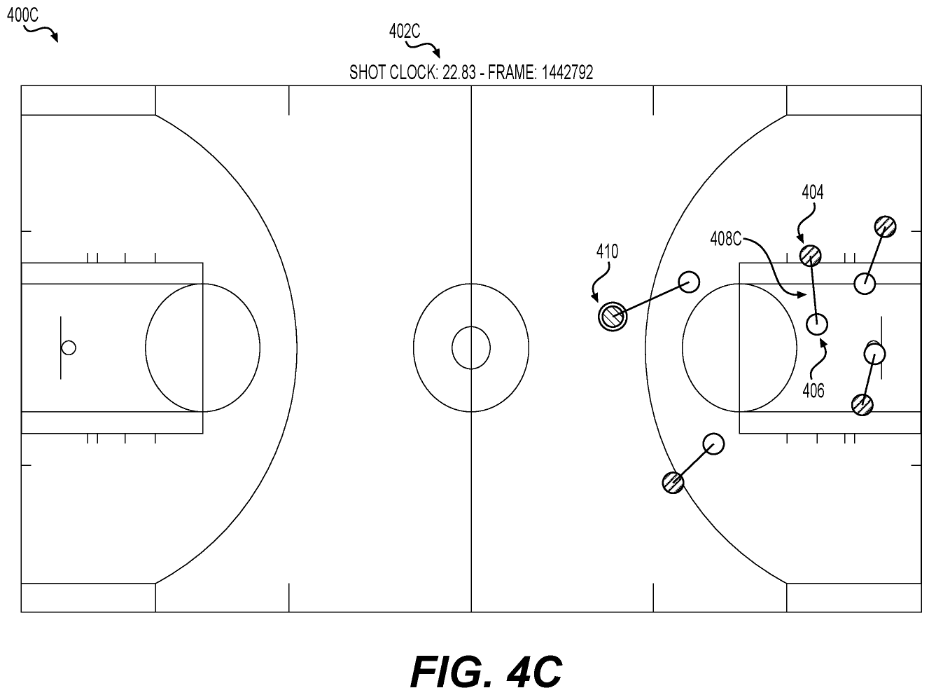

In some instances, the method can include generating, for each frame, a virtual representation of the video broadcast depicting a position of each player and a ball on a court and the distance between each defending player to each corresponding offensive player. An example virtual representation is shown with respect to FIGS. 4A-4C.

In some instances, the video remote tracking model can process the video broadcast to determine that the first defensive player has a new matchup with another offensive player. For example, if the first defensive player switches to defending another offensive player, the video remote tracking model can identify and update the matchup between the defender and the new offensive player. The video remote tracking model can also calculate an updated distance between the first defensive player and the other offensive player. The updated distance can be used in generating the defensive influence score. For example, each time the defender switches to a new offensive player, the average distance between the defender and each offensive player can be tracked and recorded for generation of the defensive influence score.

At step 306, the video remote tracking model 170 can aggregate, for each frame, the distance between a first defending player and the corresponding offensive player to generate an aggregated distance between the first defending player and the corresponding offensive player during the sporting event. The aggregated distance can be indicative of an average distance the first defending player is from the offensive player during the course of the game. In some instances, the aggregated distance can be separated by time such that the distance can be tracked based on a time the player plays during the course of the game.

At step 308, a defensive influence score model 172 can generate a defensive influence score for the first defending player based on the aggregated distance of the first defending player. The defensive influence score can include a 0-100 score specifying a relative intensity of the defender during the course of the game. In some instances, the defensive influence score comprises both an aggregate defensive influence score for the first defensive player during an entirety of the basketball game and a set of defensive influence scores for each of a set of time ranges in which the first defending player played during the basketball game.

At step 310, the fitness metric estimation model 174 can obtain both a set of offensive and defensive metrics for the first defensive player. Examples of the offensive metrics and defensive metrics can be shown in FIG. 6A-6B, respectfully.

At step 312, the fitness metric estimation model 174 can generate one or more player fitness metrics using the metrics and the defensive influence score.

At step 314, a player load prediction model 176 can predict a load for the first defensive player for an upcoming sporting event using at least the one or more player fitness metrics. The load can include any of a number of playing minutes for the first defensive player and one or more predicted defensive statistics for the first defensive player for the upcoming sporting event.

As described above, a video remote tracking model can obtain a video broadcast and generate insights into a game from the video broadcast. FIGS. 4A-C illustrate various frames of a virtual representation of a video broadcast of a basketball game, according to example embodiments. Each frame 400A-C as represented in FIGS. 4A-4C can illustrate different frames of a video broadcast and different positions of players and the ball during the course of the game.

FIG. 4A illustrates a first frame of a virtual representation of a video broadcast of a basketball game, according to example embodiments. For example, a first frame 400A can depict a frame of the video broadcast, specified by a specific shot clock timeframe and a frame number (e.g., 402A). Further, in FIG. 4A, each player can be specified as being part of either team (e.g., a team on offense, a team on defense), such as a first offensive player 404 and a first defensive player 406. A distance 408A can be tracked between each defensive player and a corresponding offensive player being guarded. The distances between players can differ between players, positions, etc. Further, the distance a player keeps to an offensive player that the defender is guarding over the course of the game can be tracked to determine a defensive influence score of the player (e.g., player 406) for each time duration during the game. Each frame can further track a location of the ball 410 as the ball moves between possession of the players.

In some instances, the video remote tracking model 170 can track possession of the ball 410 for either team. Further, the model can determine when possession changes to the defending team. In such instances, once possession changes, the video remote tracking model 170 can stop tracking distances (e.g., 408A-C), as the first defensive player (e.g., player 406) is now on offense. In some instances, distances may only start being tracked once the ball 410 crosses a half-court line.

FIG. 4B illustrates a second frame of a virtual representation of a video broadcast of a basketball game, according to example embodiments. In FIG. 4B, a second frame 400B (as shown by a unique frame number 402B), the ball 410 can be moved to a second offensive player, while the distance 408B between the first offensive player 404 and first defensive player 406 can dynamically change as the players 404, 406 move across the court. In some instances, as the player (e.g., player 406) changes guard to another player, the video remote tracking model can change the distance (e.g., 408B) to between the defensive player and a new offensive player.

FIG. 4C illustrates a third frame of a virtual representation of a video broadcast of a basketball game, according to example embodiments. In FIG. 4C, the third frame 400C (with unique frame number 402C) can have the distance 408C between player 404, 406 increase, which, when aggregated across multiple frames, can be indicative of a defensive intensity (represented in a defensive influence rating) for the player (e.g., player 406) going downwards. The distances between defending players can be tracked for each frame and aggregated in generating defensive influence ratings as described herein.

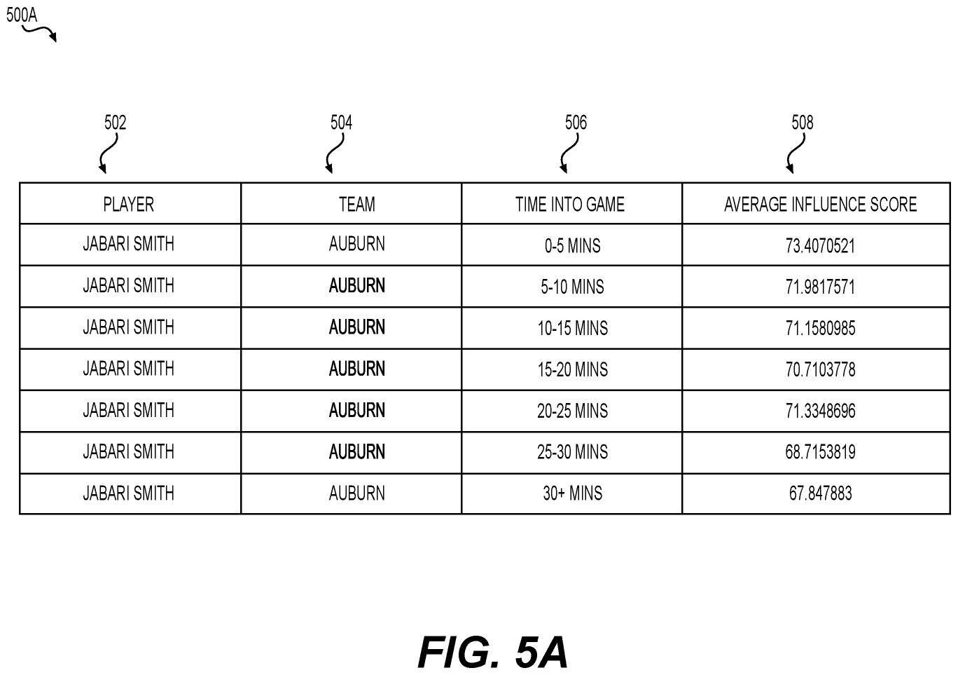

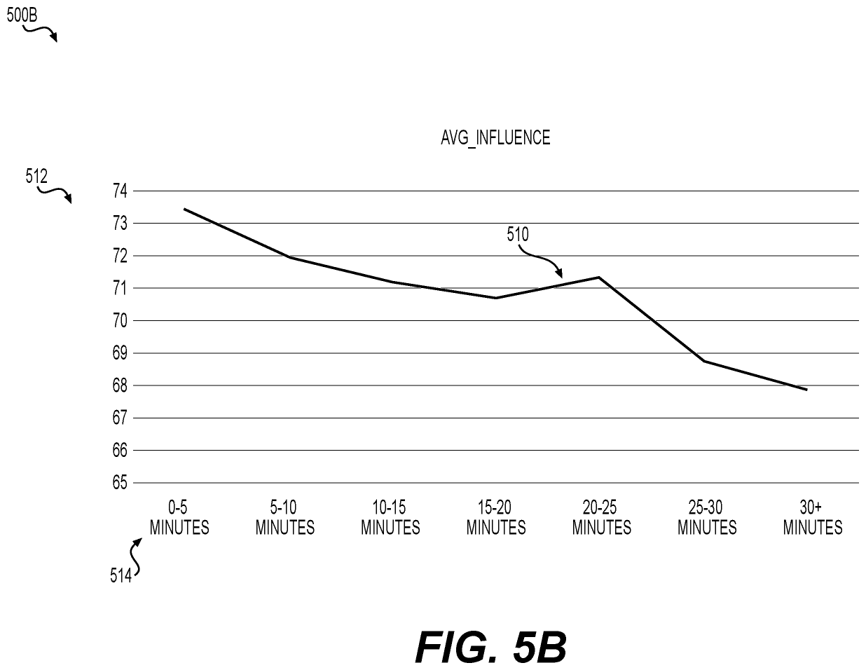

A defensive influence rating for a player can be generated for an entirety of the game in which the player was on the court. FIGS. 5A-5B illustrate representations 500A-B of an example defensive influence score for a player, according to example embodiments. For instance, FIG. 5A is a table 500A illustrating columns identifying a player 502, team 504, a time range of the game 506, and an average defensive influence score 508.

The table 500A can represent a tracked defensive influence score (e.g., 508) separated into time ranges of the game. For example, the time ranges (e.g., 506) can be separated into five-minute intervals, or can represent a number of minutes played by the player.

As can be seen in FIG. 5A, in this example, as the time into the game increases, the average defensive influence of the player can decrease, which can be indicative of various defensive metrics of the player going down as the game progresses.

FIG. 5B illustrates a graph 500B depicting a trendline 510 of an average defensive influence score (e.g., 512) of the player. The graph in FIG. 5B can illustrate the defensive influence score decreasing as the number of minutes (e.g., 514) the player plays increases. The defensive influence score can be used to derive further insights and predictions into defensive performance, such as to derive fitness metrics for the player or to predict a load for the player, for example. 100671 FIGS. 6A-6B illustrate example player cards 600A-B illustrating various offensive and defensive metrics of the player, according to example embodiments. The player cards 600A-B can summarize a series of metrics for the player. For example, offensive metrics (e.g., shown in FIG. 6A) can include shooting metrics, passing metrics, isolation metrics, ball screen metrics, etc. Defensive metrics (e.g., shown in FIG. 6B) can include shot defense metrics, rebounding metrics, isolation defense metrics, ball screen defense, etc. The player cards 600A-B can illustrate values, percentages, etc., along with a rank for the player in each metric. The rank for each metric can provide a relative ranking of the player across other players in a similar league, or across all players of a same position, for example.

### Computing System Overview

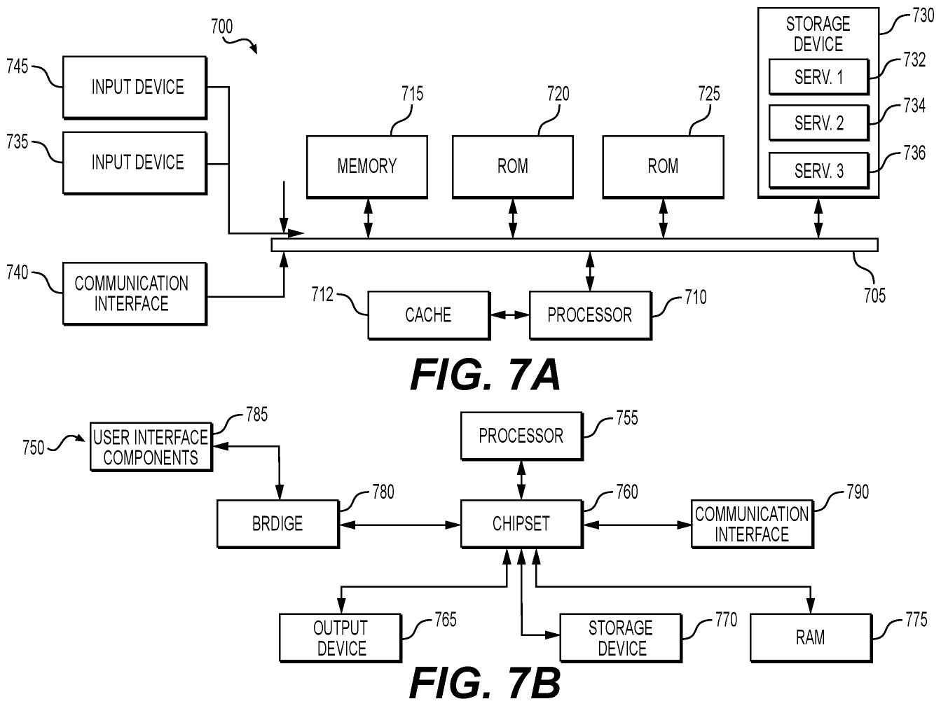

FIG. 7A illustrates a system bus computing system architecture 700, according to example embodiments. System 700 may be representative of at least a portion of organization computing system 104. One or more components of system 700 may be in electrical communication with each other using a bus 705. System 700 may include a processing unit (CPU. or processor) 710 and a system bus 705 that couples various system components including the system memory 715, such as read only memory (ROM) 720 and random-access memory (RAM) 725, to processor 710. System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with system 700, an input device 745 may represent any number of input mechanisms, such as a microphone for speech, a touch-sensitive screen for gesture or graphical input, keyboard, mouse, motion input, speech and so forth. An output device 735 may also be one or more of a number of output mechanisms known to those of skill in the art. In some instances, multimodal systems may enable a user to provide multiple types of input to communicate with system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735, and so forth, to carry out the function.

FIG. 7B illustrates a computer system 750 having a chipset architecture that may represent at least a portion of organization computing system 104. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755. In this example, chipset 760 outputs information to output 765, such as a display, and may read and write information to storage device 770, which may include magnetic media, and solid-state media, for example. Chipset 760 may also read data from and write data to RAM 775. A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage 770 or RAM 775. Further, the machine may receive inputs from a user through user interface components 785 and execute appropriate functions, such as browsing functions by interpreting these inputs using processor 755

It may be appreciated that example systems 700 and 750 may have more than one processor 710 or be part of a group or cluster of computing devices networked together to provide greater processing capability

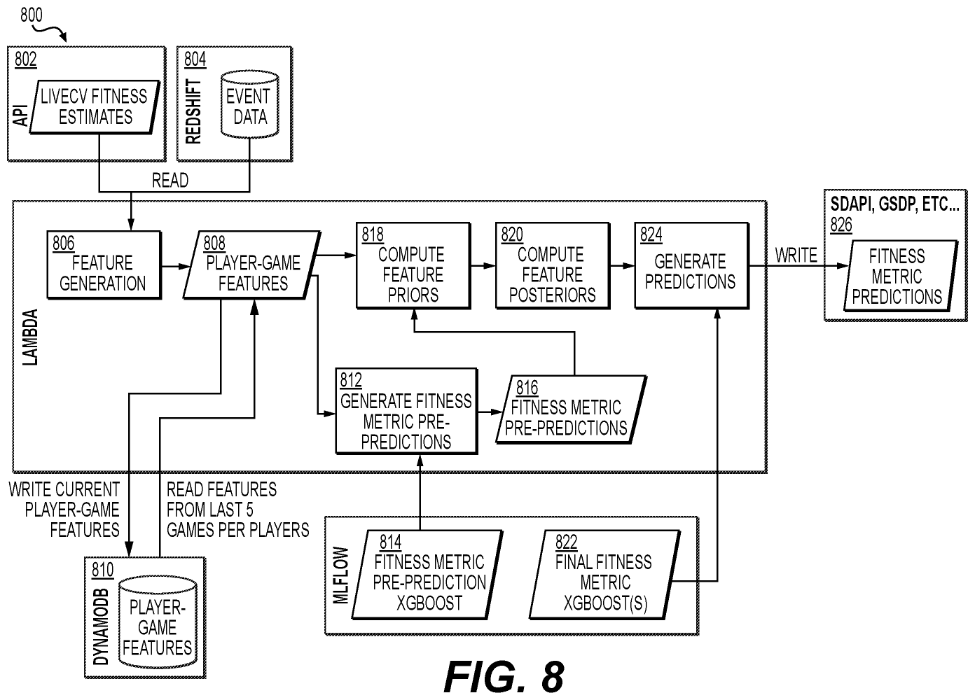

Referring to FIG. 8, in some embodiments a system and method for predicting performance metrics is provided. Existing systems for tracking player performance metrics during sporting events often rely on in-venue tracking data, which captures the locations of all players on the field, for example, approximately at least once per second throughout the entire match. However, this approach presents challenges when in-venue tracking data is not available for a particular game. In such cases, broadcast tracking data obtained from video feeds of the game can be utilized as an alternative data source. Nevertheless, broadcast tracking data introduces additional complexities, as players may be off-screen for significant portions of the match, leading to incomplete tracking information.

The present system and method address these limitations by leveraging a combination of broadcast tracking data and event data to generate comprehensive player performance predictions. Broadcast tracking data corresponds to the tracking data discussed herein which may be generated based on one or more broadcast feeds. Event data may be data related to a sporting event that is tagged or otherwise marked using an automated system (e.g., using one more machine learning models) and/or an operator. Such event data may include sports events such as, for example, passes, scoring, changes in possession, penalties, trends, etc. The system is configured to infer player movements and actions during periods when they are not visible on the broadcast feed by analyzing patterns in the available data and applying machine learning techniques. Such machine learning techniques may use machine learning models that are trained to modify corresponding weights, layers, biases, synapses, and/or the like based on training data that includes, for example, historical or simulated sporting matches that may be tagged to include such sporting events. This approach enables the generation of fitness metrics and physical performance predictions even in the absence of complete in-venue tracking data.

Some of the advantages of the present system include improved accuracy and reliability of player performance predictions, particularly in scenarios where in-venue tracking data is not available. By utilizing broadcast tracking data and event data in conjunction with advanced machine learning algorithms, the system is configured to generate comprehensive insights into player fitness, movement patterns, and physical performance. This enables coaches, analysts, and other stakeholders to make informed decisions regarding player selection, training regimens, and tactical strategies, even when faced with limited data availability. Additional technical advantages are evidenced by the descriptions of the systems and methods provided herein.

In some embodiments, the present system and method for predicting player performance metrics encompasses a comprehensive technological solution that leverages a variety of hardware and software components. The system ingests data from multiple sources, including broadcast tracking data obtained from video feeds of sporting events and event data captured by in-venue tracking systems. These data sources are processed by specialized software modules, such as the video remote tracking model 170 and the pre-processing agent 156, which may be executed on a computing system, such as the organization computing system 104. The processed data is then stored in one or more data stores, such as the data store 158. The system's predictive models, which may include the defensive influence score model 172, the fitness metric estimation model 174, and the player load prediction model 176, are implemented as software modules that utilize the processed data to generate accurate and reliable player performance predictions. These models leverage the computational power of the organization computing system 104 to perform complex analytical tasks and deliver insights to end-users via the client device 108 and its associated application 132. The integration of these hardware and software components forms a technological solution that addresses the challenges of predicting player performance in the absence of in-venue tracking data, such as by leveraging only broadcast tracking data and one or more models trained based at least partly on in-venue tracking systems.

In some embodiments, the present system is configured to generate and predict a wide array of physical metrics that provide valuable insights into player performance and fitness. These metrics may include, but are not limited to, total distance covered, distance sprinted, number of sprints, average speed, top speed, distance covered at various speed thresholds (e.g., walking, jogging, running, high-speed running, sprinting), number of accelerations and decelerations at different intensity levels, and the like. The system is designed to be flexible and can accommodate the generation and prediction of custom metrics based on specific requirements or interests of the users, such as by changing thresholds for the classification of various physical metrics. For example, the threshold for defining a sprint may be lowered to accommodate for variances in one or more leagues (e.g. by gender, by age, by tier, or the like). Predictions can be made at various time frames, depending on the needs of the organization and the availability of data. For instance, the system may generate predictions after every game, providing a comprehensive assessment of each player's performance throughout the entire match. Alternatively, predictions can be made at the end of each period within a game, offering a more granular analysis of player performance and fitness fluctuations over the course of the event. In situations where real-time insights are desired, the system is capable of generating predictions at even more frequent intervals, such as every few minutes or on-demand, subject to the availability of input data and computational resources.

Referring to FIG. 8, the flow process 800 illustrates the various steps and components involved in predicting one or more player metrics using the present system. The process begins with the acquisition of incoming data, which may be received from one or more sources, includes API 802 and event data 804. The API 802 serves as a conduit for retrieving relevant data from external systems or databases, such as fitness estimates of players based on historical player and team data. This data may include information about a player's past performance, physical attributes, and overall fitness levels, which can serve as valuable inputs for predicting future performance. On the other hand, the event data 804 encompasses actual data captured by in-venue or broadcast based tracking systems during sporting events. This data may include player positions, movements, and actions throughout the course of a game, as well as various statistics and metrics derived from the raw tracking data. The event data 804 provides a detailed account of what transpired during a specific game and forms the basis for generating accurate predictions of player performance. Further, the data received may include information related to a broadcast of a sporting event, such as the live video broadcast feed of the event. In some embodiments, the incoming data from API 802 and event data 804 is collected and stored in a centralized repository, such as the data store 158 of the organization computing system 104.

In some embodiments, once the incoming data from API 802 and event data 804 has been collected and stored, the system proceeds to feature generation 806. Feature generation may involve extracting meaningful information from the raw data and transforming it into a format that can be effectively utilized by the system's predictive models. In some embodiments of the present system, feature generation encompasses three distinct aspects: event-based features derived from event data, aggregated fitness metrics derived from broadcast tracking data, and aggregated fitness metrics derived from in-venue tracking data. Each of these aspects contributes unique and valuable insights into player performance and fitness, and their combination enables the system to generate comprehensive and accurate predictions.

In some embodiments, the generation of event-based features from event data 804 involves extracting meaningful information from various sources, such as player and team box scores, and using this information to create a comprehensive representation of player actions and team dynamics during a game. The generation of event-based features may include generating the imputation of a ball trajectory. The system analyzes the available event data to estimate the path and movement of the ball throughout the game, even when the ball is not directly tracked. This imputed ball trajectory provides a continuous representation of the game flow and enables the system to infer player actions and interactions in relation to the ball's position.

In some embodiments, the system derives player boxscore metrics from the event data, which quantify individual player actions and contributions. These metrics may include measures such as carry distance and duration per 90 minutes of play, which reflect a player's ability to maintain possession and advance the ball. Additionally, the system calculates the number of passes made and received per 90 minutes, as well as the mean x-coordinate of these passes, which provides insights into a player's passing activity and the areas of the field in which they tend to operate, among other metrics.

Team boxscore metrics are also generated and/or retrieved when a player is on the pitch, capturing the collective performance and actions of the team as a whole. These metrics may encompass various aspects of team play, such as the total number of passes, shots, and goals during the time the player is on the field. By considering team-level metrics in conjunction with individual player metrics, the system can better understand the player's contribution within the context of their team's overall performance.

In some embodiments, the system incorporates team style features derived from the event data. These features capture the underlying playing style and tactics employed by each team, such as their tendency to play possessional football, their level of defensive pressure, and their propensity for creating scoring opportunities. The inclusion of team style features allows the system to consider the influence of team tactics on individual player performance and provides a more nuanced understanding of the game dynamics.

In some embodiments, the system may generate event-based features that capture the relative strength and performance of teams and different levels of competition, which for example may be international and junior level teams. These techniques involve the creation of international Power Rankings, which provide a standardized measure of team quality across different age groups and competition levels. For men's and women's senior teams, the system leverages the prior information provided by the FIFA Elo ratings as a starting point. However, for junior level teams (e.g., U21s, U19s, U16s), the system employs a more sophisticated approach, analyzing the club team proprietary power rankings of the players representing each junior national team and adjusting these rankings based on the proportion of available minutes played by each player for their club and international teams. In some embodiments, the power rankings are derived from a proprietary power ranking system and methodology, which may in some embodiments be performed by the present system. For example, if a player consistently plays a high proportion of minutes for a top-ranked club team, their contribution to their junior national team's Power Ranking will be weighted more heavily. Conversely, if a player receives limited playing time for a lower-ranked club team, their impact on their junior national team's Power Ranking will be proportionally reduced.

In cases where there is insufficient information to directly infer a junior team's Power Ranking, the system utilizes the prior power ranking of the senior equivalent team as a proxy. This approach is based on the assumption that the relative strength of a junior team is likely to be correlated with the strength of the corresponding senior team. To refine this estimate, the system applies a scaling factor derived from the average ratio of club Power Rankings for players in the same age cohort across all international teams. For instance, if the average club Power Ranking of players in the men's U19 age group is found to be 65% of the average club Power Ranking of senior players, this scaling factor (0.65) is applied to the senior team's Power Ranking to estimate the corresponding U19 team's Power Ranking.

In cases where there is insufficient information to directly infer a junior team's Power Ranking, the system utilizes the prior of the senior equivalent team as a proxy and applies a scaling factor derived from the average ratio of club Power Rankings for players in the same age cohort across all international teams. The resulting international Power Rankings are dynamically updated based on the latest available data and stored in the data store 158 alongside other event-based features. The inclusion of these rankings as event-based features enables the predictive models to consider the influence of team quality on individual player outcomes, leading to more accurate and contextualized predictions of player performance and development potential. It will be understood that the junior team-based implementation described herein is an example. Such related techniques may be implemented for any team that lacks sufficient historical data or direct performance metrics. This approach can be extended to other sports, leagues, or competitions where there is a hierarchical structure or a relationship between different levels of play.

In some embodiments, the system generates aggregated fitness metrics derived from broadcast tracking data, which is obtained from video feeds of the sporting event. This process involves analyzing the positions and movements of players during the portions of the game that are captured by the cameras and extracting relevant information to calculate various fitness metrics.

The first step in this process is to apply a fitness calculator model to the broadcast tracking data. The fitness calculator model is a machine learning algorithm that is trained to estimate fitness metrics based on the available player tracking data. This model takes into account factors such as the distance covered by each player, their speed, acceleration, and deceleration, as well as the duration and intensity of their movements. The model is designed to handle the specific challenges associated with broadcast tracking data, such as the intermittent visibility of players and the potential for occlusions or missed detections.

Once the fitness calculator model has processed the broadcast tracking data, it generates a set of estimated fitness metrics for each player. These metrics may include total distance covered, distance covered at different speed thresholds (e.g., walking, jogging, running, sprinting), number of high-intensity runs, and other relevant measures of physical exertion. The estimated fitness metrics are then aggregated over the duration of the game or specific time intervals, providing a summary of each player's physical performance. These aggregated fitness metrics serve as input features for the subsequent stages of the system, particularly the pre-model, which predicts player fitness and performance based on historical data. By incorporating these broadcast-derived fitness metrics, the system is able to leverage valuable information about player movement and exertion when in-venue tracking data is not available.

In some embodiments, the system also generates aggregated fitness metrics derived from in-venue tracking data, which is captured by dedicated tracking systems installed within the sporting venue. In-venue tracking data provides a comprehensive and continuous record of player positions and movements throughout the entire game, offering a highly accurate and detailed view of player performance. Such aggregate fitness metrics may be used (e.g., as training data) to train a machine learning model disclosed herein.

The process of generating aggregated fitness metrics from in-venue tracking data begins with the application of a fitness calculator model, which may be the same model used for broadcast tracking data. However, in this case, the model has access to a more complete and precise set of input data, enabling it to produce more accurate estimates of player fitness metrics. The fitness calculator model processes the in-venue tracking data, taking into account factors such as the distance covered by each player, their speed, acceleration, and deceleration, as well as the duration and intensity of their movements.

Once the fitness calculator model has processed the in-venue tracking data, it generates a comprehensive set of fitness metrics for each player. These metrics may include total distance covered, distance covered at different speed thresholds (e.g., walking, jogging, running, sprinting), number of high-intensity runs, and other relevant measures of physical exertion. The fitness metrics derived from in-venue tracking data are then aggregated over the duration of the game or specific time intervals, providing a detailed summary of each player's physical performance. These aggregated fitness metrics serve as ground-truth values for training and validating the system's predictive models, particularly the pre-model and the overall fitness metric estimation model. By leveraging the high-quality and comprehensive data provided by in-venue tracking systems, the aggregated fitness metrics derived from this source enable the system to build accurate and robust models for predicting player fitness and performance, even in situations where in-venue tracking data may not be available for future games.

In some embodiments, the player-game features 808 represent a set of one or more attributes that capture the historical performance and characteristics of each player, as well as the team and position-specific dynamics. These features are generated by accessing and updating the database 810, which stores information about player performance, team tactics, league-specific trends, and the like. The database 810 is continuously and/or periodically updated with the latest data from both in-venue and broadcast tracking systems, ensuring that the player-game features 808 reflect the most recent and relevant information available.

In some embodiments, the player-game features 808 incorporate historical information about a player's physical performance metrics. A player's past performance can provide valuable insights into their expected performance in the current game. For example, if a player has consistently recorded high top speeds in previous matches, it is more likely that they will maintain that level of performance in the current game. Similarly, the system takes into account the typical performance metrics associated with different positions on the field. For example, in the context of soccer, goalkeepers are expected to cover significantly less distance per 90 minutes compared to central midfielders, who are known for their high work rate and extensive movement across the pitch.

In addition to individual player characteristics, the player-game features 808 may also capture team-level and position-specific dynamics. Certain teams may have distinct playing styles or tactical approaches that influence the physical demands placed on their players. For example, players on a first team may be expected to perform a higher number of high-intensity accelerations per 90 minutes compared to players on a second team, due to differences in their pressing and counter-attacking strategies. Moreover, the combination of team and position can further refine the expectations for player performance. Wingers on a third team, for instance, may be known for their high number of sprints per 90 minutes, a characteristic that sets them apart from wingers playing for other teams.

In some embodiments, to leverage this historical information, the system employs a hierarchical updating weighted average approach, which in some embodiments approximates the Empirical Bayes method. This approach generates a posterior estimate of a player's performance metrics by considering their recent individual performance, such as shown at 820 in FIG. 8, as well as the performance of players in similar positions and teams. When a threshold amount (which may be a minimum amount) of individual player data is available and/or has been observed (e.g., 450 minutes of playing time), the posterior estimate is based solely on the player's own performance. However, when limited individual data is available, the system supplements it with prior information from the team-position level, using a 1:1 weighting scheme until the minimum threshold of 450 minutes is reached. If team-position data is also insufficient, the system further leverages position-level information calculated using all teams in the dataset. This hierarchical approach allows for the generation of personalized posterior estimates that adapt to the available data, ensuring that the player-game features 808 provide the most accurate and reliable representation of each player's expected performance.

The pre-prediction model 814 generates fitness metric pre-predictions 812 by leveraging historical in-venue tracking data. The model is configured to estimate player performance metrics for matches where in-venue tracking data is not available, using the wealth of historical data from matches where both in-venue and broadcast tracking data are present. By learning the relationships between the two data sources, the pre-prediction model 814 can provide valuable insights into player performance, even in the absence of complete in-venue tracking information.

In some embodiments, the fitness metric pre-predictions 812 generated by the pre-prediction model 814 serve as an additional input to the overall player performance prediction system. These pre-predictions are incorporated into the feature priors 818, which represent a set of prior expectations about player performance based on historical data. By combining the pre-predictions with other relevant features, such as player characteristics, team tactics, and league trends, the system creates a robust and informative prior distribution that captures factors influencing player performance.

The pre-model enables the utilization of valuable in-venue tracking data that would otherwise remain unused. The pre-model is trained using a combination of broadcast tracking data features and in-venue physical performance metrics as ground-truth labels. This approach allows the pre-model to learn the complex relationships between the two data sources and to generate accurate predictions of in-venue metrics based on the available broadcast data. By leveraging historical games where both data types are available, the pre-model can extend the system's predictive capabilities to matches where only broadcast tracking data is present, thereby maximizing the use of available data and improving the overall accuracy of the fitness predictions.

Still referring to FIG. 8, in some embodiments the process 800 generates player performance predictions 824 using one or more fitness metric models, which may include three distinct fitness metric models 822: an overall model, an in-possession model, and an out-of-possession model. These models are configured to process a wide array of input features, including player and team metadata, match-specific metrics, and historical performance data, to generate predictions of player physical performance. The resulting predictions are then stored in one or more databases as fitness metric predictions 826, which can be accessed and utilized by various stakeholders, such as coaches, analysts, and sports scientists, to inform decision-making processes and optimize player management strategies.

In some embodiments, the overall model is configured to generate predictions of player physical performance metrics by considering a diverse set of input features that capture both player-specific characteristics and team-level dynamics. The model incorporates player metadata, such as the player's position (e.g., goalkeeper, central defender, etc.), the number of minutes played in the match, and the time at which the player entered the match (i.e., starters=0 minutes; substitutes=60 minutes). These features provide context about the player's role and expected physical demands within the team.

In some embodiments, the overall model also considers team metadata, including the player's team's Power Ranking and the Power Ranking difference between the player's team and the opposing team. These features capture the relative strength and competitiveness of the teams involved in the match, which can influence the intensity and physical demands placed on individual players. Additionally, the model incorporates team features from the current match, such as the proportion of time the player's team spent in winning, drawing, or losing game states, the proportion of time spent in possession or out of possession, and the total minutes of ball-in-play time. These features provide insights into the overall flow and dynamics of the match, which can impact player physical performance.

In some embodiments, the overall model leverages player boxscore posteriors, which as discussed may be derived using player, team, and/or position priors. These features include metrics such as carry distance and duration per 90 minutes (p90), number of passes made and received p90, and the mean x-coordinate of passes made and received. By incorporating these historical performance metrics, the model can capture player-specific tendencies and patterns that are likely to influence their physical output in the current match. Similarly, the model considers team style posteriors, which leverage and/or utilize team priors, providing insights into the team's typical playing style and tactics, which can impact the physical demands placed on individual players.

In some embodiments, the overall model also incorporates physical performance metric estimates derived from broadcast tracking data. These features include metrics such as distance run (in meters), distance covered at high speed (according to one or more thresholds which define a ‘high speed’ range) and other relevant measures of physical exertion. The model also considers the number of minutes the player was tracked in the broadcast data, providing context for the reliability and completeness of the physical performance estimates. Additionally, the model leverages physical performance metric predictions generated by the pre-model, which utilizes historical in-venue tracking data to estimate player performance in the absence of complete in-venue tracking data.

In some embodiments, the in-possession and out-of-possession models are configured to generate independent predictions of player physical performance metrics based on a subset of the features used by the overall model. These models focus specifically on the periods of the match when the player's team is in possession of the ball or out of possession, respectively. By generating separate predictions for these distinct phases of play, the system can provide a more granular and nuanced understanding of player physical performance.

In some embodiments, the in-possession model may incorporate player metadata, such as the player's position, along with in-possession team style features from the current match (e.g., in-possession features 0, 1, 2, 3, 4 . . . n). These features capture the team's typical playing style and tactics when in possession of the ball, which can influence the physical demands placed on individual players. The in-possession model also considers team features from the current match, such as the total ball-in-play time, the proportion of time the player's team spent in possession, and the number of open-play turnovers committed by the player's team. These features provide context for the team's overall possession-based performance and the potential physical demands associated with maintaining or regaining possession. Additionally, the in-possession model incorporates ball-related features, such as the distance the ball moved, the distance the ball gained towards the team's own goal, and the mean ball speed when the player's team was in possession. These features capture the dynamic nature of possession-based play and the associated physical demands placed on players. Lastly, the in-possession model leverages the physical performance metric predictions generated by the overall model, allowing for a more comprehensive and contextualized understanding of player performance during possession phases. One or more of these metrics and/or features may serve as inputs to the in-possession model for the generation of fitness metric predictions.

In some embodiments, the out-of-possession model incorporates player metadata, such as the player's position, along with out-of-possession team style features from the current match (e.g., out-of-possession features 0, 1, 2, 3, 4 . . . n). These features capture the team's typical defensive structure, pressing intensity, and other tactical elements when out of possession, which can influence the physical demands placed on individual players. The model also considers team features from the current match, such as the total ball-in-play time, the proportion of time the player's team spent out of possession, and the number of open-play turnovers committed by the player's team. These features provide insights into the overall defensive workload and the potential physical demands associated with regaining possession or maintaining defensive shape. Additionally, the out-of-possession model incorporates ball-related features, such as the distance the ball moved, the distance the ball gained towards the team's own goal, and the mean ball speed when the player's team was out of possession. These features capture the dynamic nature of defensive play and the associated physical demands placed on players, such as tracking opposition movements, closing down spaces, and making defensive recoveries. Lastly, the model leverages the physical performance metric predictions generated by the overall model, allowing for a more comprehensive and contextualized understanding of player performance during out-of-possession phases. One or more of these metrics and/or features may serve as inputs to the out-of-possession model for the generation of fitness metric predictions.

In some embodiments, to ensure that the sum of the in-possession and out-of-possession predictions aligns with the overall predictions for each player, the system employs an adjustment process. This process maintains the relative proportions of the in-possession and out-of-possession predictions while ensuring that their sum matches the overall prediction. For example, if a player is predicted to perform 12 sprints by the overall model, with 6 sprints predicted by the in-possession model and 5 sprints predicted by the out-of-possession, the system adjusts the in-possession prediction out-of-possession predictions to account for the disparity in the total predicted sprints from the in-possession and out-of-possession models and the total sprints predicted by the overall model. This adjustment is, in some embodiments, linear. This adjustment process guarantees that the individual possession-based predictions provide a detailed breakdown of the player's physical performance while remaining consistent with the overall prediction.

In some embodiments, the fitness metric models 822 are implemented using machine learning techniques, such as gradient boosting or deep learning algorithms. These models are trained on large datasets containing historical player performance data, match details, and relevant contextual information. The training process involves iteratively adjusting the model parameters to minimize the difference between the predicted and actual physical performance metrics, using techniques such as cross-validation and hyperparameter tuning to optimize model performance and generalization. Once trained, the models can be applied to new, unseen data to generate predictions of player physical performance for upcoming matches or to analyze past performances in greater detail. The flexibility and adaptability of the machine learning approach allow for the continuous improvement and refinement of the fitness metric models as new data becomes available, ensuring that the system remains up-to-date and relevant in the face of evolving player characteristics, tactical trends, and match dynamics.

While one or more sports are is generally used herein as an illustrative example, such as basketball and/or soccer, the present embodiments are not limited to basketball and/or soccer. For instance, the present embodiments can be applied to other sports, such as soccer, basketball, baseball, football, rugby, cricket, team sports, individual sports, and the like. It will be appreciated that terminology may be interchangeable between sports, such as “court” being interchangeable with field of play.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method comprising:
obtaining a video broadcast of a sporting event;
processing each frame of the video broadcast to identify players on a first team and a second team, a location of each identified player, a matchup between each defending identified player and a corresponding offensive identified player, and a distance between each defending identified player and the corresponding offensive identified player;
aggregating, for each frame, the distance between a first defending identified player and a first offensive identified player that the first defending identified player is matched up against to generate an aggregated distance between the first defending identified player and the first offensive identified player during the sporting event; and
generating a defensive influence score for the first defending identified player based on the aggregated distance of the first defending identified player.

2. The method of claim 1, wherein the defensive influence score comprises both an aggregate defensive influence score for the first defending identified player during an entirety of the sporting event and a set of defensive influence scores for each of a set of time ranges in which the first defending identified player played during the sporting event.

3. The method of claim 1, further comprising:
obtaining both a set of offensive and defensive metrics for the first defending identified player; and
generating one or more player fitness metrics using the metrics and the defensive influence score.

4. The method of claim 3, further comprising:
predicting a load for the first defending identified player for an upcoming sporting event using at least the one or more player fitness metrics, the load comprising any of a number of playing minutes for the first defending identified player and one or more predicted defensive statistics for the first defending identified player for the upcoming sporting event.

5. The method of claim 3, further comprising:
processing one or more frames of the video broadcast to detect an occurrence of an offensive event; and
predicting a player effort of the first offensive identified player in response to the detected offensive event using both the defensive influence score and the one or more player fitness metrics.

6. The method of claim 1, wherein the video broadcast is a live broadcast or a replay of the sporting event.

7. The method of claim 1, further comprising:
generating, for each frame, a virtual representation of the video broadcast depicting a position of each identified player and a ball on a court and the distance between each defending identified player to each corresponding offensive identified player.

8. The method of claim 1, further comprising:
processing the video broadcast to determine that the first defending identified player has a new matchup with another offensive identified player; and
calculating an updated distance between the first defending identified player and the another offensive identified player, wherein the updated distance is used in generating the defensive influence score.

9. A system comprising:
a processor; and
a memory having programming instructions stored thereon, which, when executed by the processor, performs one or more operations comprising:
obtaining a video broadcast of a sporting event;
processing each frame of the video broadcast to identify players on a first team and a second team, a location of each identified player, a matchup between each defending identified player and a corresponding offensive identified player, and a distance between each defending identified player and the corresponding offensive identified player;
aggregating, for each frame, the distance between a first defending identified player and a first offensive identified player that the first defending identified player is matched up against to generate an aggregated distance between the first defending identified player and the first offensive identified player during the sporting event; and
generating a defensive influence score for the first defending identified player based on the aggregated distance of the first defending identified player.

10. The system of claim 9, wherein the operations further comprise:
obtaining both a set of offensive and defensive metrics for the first defending identified player;
generating one or more player fitness metrics using the metrics and the defensive influence score; and
predicting a load for the first defending identified player for either a remainder of the sporting event or an upcoming sporting event using at least the one or more player fitness metrics.

11. The system of claim 10, wherein the load comprises any of a number of playing minutes for the first defending identified player and one or more predicted defensive statistics for the first defending identified player for the upcoming sporting event.

12. The system of claim 9, wherein the defensive influence score comprises both an aggregate defensive influence score for the first defending identified player during an entirety of the sporting event and a set of defensive influence scores for each of a set of time ranges in which the first defending identified player played during the sporting event.

13. The system of claim 10, wherein the operations further comprise:
processing one or more frames of the video broadcast to detect an occurrence of an offensive event; and
predicting a player effort of the first offensive identified player in response to the detected offensive event using both the defensive influence score and the one or more player fitness metrics.

14. The system of claim 10, wherein the operations further comprise:
generating, for each frame, a virtual representation of the video broadcast depicting a position of each identified player and a ball on a court and the distance between each defending identified player to each corresponding offensive identified player.

15. The system of claim 10, wherein the operations further comprise:
processing the video broadcast to determine that the first defending identified player has a new matchup with another offensive identified player; and
calculating an updated distance between the first defending identified player and the another offensive identified player, wherein the updated distance is used in generating the defensive influence score.

16. A non-transitory computer readable medium including one or more sequences of instructions that, when executed by one or more processors, causes the one or more processors to:
obtain a video broadcast of a sporting event;
process each frame of the video broadcast to identify at least players on a first team and a second team, a location of each identified player, a matchup between each defending identified player and a corresponding offensive identified player, and a distance between each defending identified player and the corresponding offensive identified player;
aggregate, for each frame, the distance between a first defending identified player and a first offensive identified player that the first defending identified player is matched up against to generate an both aggregated distance between the first defending identified player and the corresponding offensive identified player during an entirety of the sporting event and average distances between the first defending identified player and the first offensive identified player during a set of time ranges in which the first defending identified player played during the sporting event; and
generate a defensive influence score for the first defending identified player based on the aggregated distance of the first defending identified player, wherein the defensive influence score comprises both an aggregate defensive influence score for the first defending identified player for the entirety of the sporting event and a set of defensive influence scores for each of the set of time ranges in which the first defending identified player played during the sporting event.

17. The non-transitory computer readable medium of claim 16, wherein the instructions further cause the processor to:
obtaining both a set of offensive and defensive metrics for the first defending identified player; and
generating one or more player fitness metrics using the metrics and the defensive influence score.

18. The non-transitory computer readable medium of claim 17, wherein the instructions further cause the processor to:
predict a load for the first defending identified player for an upcoming sporting event using at least the one or more player fitness metrics, the load comprising any of a number of playing minutes for the first defending identified player and one or more predicted defensive statistics for the first defending identified player for the upcoming sporting event.

19. The non-transitory computer readable medium of claim 17, wherein the instructions further cause the processor to:
process one or more frames of the video broadcast to detect an occurrence of an offensive event; and
predict a player effort of the first offensive identified player in response to the detected offensive event using both the defensive influence score and the one or more player fitness metrics.

20. The non-transitory computer readable medium of claim 16, wherein the instructions further cause the processor to:
process the video broadcast to determine that the first defensive identified player has a new matchup with another offensive identified player; and
calculate an updated distance between the first defending identified player and the another offensive identified player, wherein the updated distance is used in generating the defensive influence score.
